(19) United States
(12) Patent Application Publication
(10) Pub. No.: US 2012/0125078 A1
(43) Pub. Date: May 24, 2012

(54) SONIC WAVE PINCH DETECTION SYSTEM AND METHOD FOR A MOVABLE PANEL

(75) Inventors: Phillip IOTT, Troy, MI (US); Hong Nguyen, Rochester Hills, MI (US); Walter Soon, Flint, MI (US); Trevor Johnson, Swartz Creek, MI (US); Robert Looyengood, Carson City, MI (US)

(73) Assignee: Webasto Roof Systems Inc., Rochester Hills, MI (US)

(21) Appl. No.: 12/951,951

(22) Filed: Nov. 22, 2010

(51) Int. Cl. G01N 29/11; G01N 29/30

(52) U.S. Cl. 73/1.82; 73/599

(57) ABSTRACT

A pinch detector for a movable panel is provided having a deformable and resilient channel; a sonic wave transmitter at one end of the channel having a predetermined output; a sonic wave receiver at a second end of the channel; and a controller connected to the transmitter and receiver; wherein the controller selectively activates the transmitter and generates a command in response to a predetermined attenuation of sonic wave input from the sonic wave receiver. The predetermined output of the sonic wave transmitter is in the range of about 30 to 50 kHz at a range of about 3 to 24 volts, but is preferably about 40 kHz at about 5 volts. The deformable and resilient channel can be disposed within a sealing element of a movable panel. Optionally, the sonic wave can be modulated. Compositions for the sonic tube can include latex, rubber, EPDM, foam, combinations thereof, and the like.

### FIELD

The present embodiments generally relate to pinch detection from movable panels, such as for an opening of a vehicle roof, and particularly to a pinch detection system and method for a movable panel using integrated sonic waves transmitted within a deformable and resilient channel.

### BACKGROUND

In the art, sunroofs, moon roofs and other movable surfaces/panels (“movable panels”) installed to cover an opening of a vehicle roof are known. Through the years, various mechanisms have been developed to allow the sunroof to move and tilt. In some applications, a sunroof can be moved by the use of a drive mechanism disposed within a slide track attached to the vehicle. A sealing element is typically mounted on the stationary roof part, which projects into the roof opening around its periphery. The sealing element can provide a desired weather-tight seal when the movable panel is in a closed position. When the panel is moving from an open or tilted position to a closed position, it can be desirable to have a system with a controller to sense when the panel has reached its closed position or to sense whether an obstruction is between the panel and the seal. This type of system is often referred to as a pinch detection system. The pinch detection system can stop or reverse panel movement in response to sensing obstructions or complete closure (i.e., end-point position).

There is known art which discloses various possibilities for detecting panel closure or pinching of, for example, an article or body part by a sun roof, moon roof, garage door, and the like. Some possibilities can use pressure sensors (U.S. Pat. No. 6,186,586), optic sensors (U.S. Pat. No. 7,026,930), panel motor speed and electrical capacitance (U.S. Pat. No. 6,592,178), and the like.

Specifically, pinch detection can be accomplished for movable panels by monitoring a panel drive motor. Here, the motor current, its change over time, or its torque can be monitored (e.g., by Hall Effect). See, for example, published German Patent Applications DE 198 40 161 A1, DE 198 40 162 A1, DE 198 40 163 A1, and DE 198 40 164 A1 and its counterpart U.S. Pat. No. 6,753,676, German Patent DE 33 29 986 C2, published German Patent Application DE 196 18 219 A1, and its counterpart U.S. Pat. No. 6,070,116 and German Patent DE 195 07 541 C1 and its counterpart U.S. Pat. No. 5,764,008.

Additionally, specific pressure sensors for pinch detection are known, for example, from published German Patent Applications DE 37 31 428 A1 and DE 195 35 796 A1 and German Patent DE 197 50 711 C2 and its counterpart U.S. Pat. No. 6,076,886. Here pinch sensors are mounted on the front edge of the cover or the front edge of the roof opening, and can be formed, for example, as piezoelectric pressure sensors in the form of optical fibers or as FSR sensor elements which change their resistance under pressure.

Although these pinch detection systems (which are incorporated herein by reference) represent great advances in the art, further advances are possible and desired. For example, pressure sensors typically must be provided over the entire width of the roof opening to accomplish effective pinch detection. This can add considerable cost to a sunroof module system. Further considerations can include that such systems can require considerable space within a sunroof module, emit radiated emissions from RF signals, fragility over the design life of a product, and being disabled if any part of the system is breached, cut or nicked.

One solution, presently unknown in the art, may include the use of sonic waves. Sonic wave applications have been attempted for measuring distance (U.S. Pat. No. 7,699,141), pipeline leaks (U.S. Pat. No. 6,442,999) and loss of vacuum (U.S. 4,574,615). Nevertheless, such application to solve panel closure detection or pinch detection is unknown.

### SUMMARY

Accordingly, the present embodiments generally relate to pinch detection from movable panels, such as for an opening of a vehicle roof, and particularly to a pinch detection system and method for a movable panel using integrated sonic waves transmitted within a deformable and resilient channel.

In one embodiment, a pinch detection system of the present embodiments can have a deformable and resilient channel; a sonic wave transmitter at one end of the channel having a predetermined output; a sonic wave receiver at a second end of the channel; and a controller connected to the transmitter and receiver; wherein the controller selectively activates the transmitter and then generates a command in response to a predetermined attenuation of sonic wave input from the sonic wave receiver. The predetermined output of the sonic wave transmitter is in the range of about 30 to 50 kHz at a range of about 3 to 24 volts, but is preferably about 40 kHz at about 5 volts. The deformable and resilient channel can be disposed within a sealing element of a movable panel. Optionally, the sonic wave can be modulated. Compositions for the sonic tube can include latex, rubber, EPDM, foam, combinations thereof, and the like.

The present embodiments can be calibrated to improve predictability of the sonic tube pinching by calibrating for present channel temperature, thermistor temperature, number of channel bends, interior surface finish of the channel, channel composition, channel breaches, channel length, sonic tube wall thickness, sonic wave frequency and amplitude, anticipated background noise, combinations thereof, and the like.

The present embodiments can provide several commands in response to passing a predetermined threshold attenuation such as activating an LED, activating an audible sound, commanding a movable panel to stop movement, reversing movable panel direction, combinations thereof, and the like. In one embodiment, the predetermined threshold can be about 3.2 volts or less after calibration.

Methods of the present embodiments can include: generating a sonic wave at one end of the channel at a predetermined output; sensing the sonic wave at a second end of the channel at a predetermined input; and outputting a signal in response to a predetermined attenuation of the sensed sonic wave. Optionally, the sonic wave can be modulated.

Other features will become more apparent to persons having ordinary skill in the art which pertains from the following description and claims.

### BRIEF DESCRIPTION OF THE DRAWINGS

The foregoing features, as well as other features, will become apparent with reference to the description and Figures below, in which like numerals represent like elements, and in which:

FIG. 1 is an exemplary general schematic of a pinch detection system using sonic waves according to the present embodiments.

FIG. 2 is an exemplary system diagram of a pinch detection system using sonic waves according to the present embodiments.

FIG. 3 is an exemplary hardware block diagram of a pinch detection system using sonic waves according to the present embodiments.

FIG. 4 is a planar top view of a vehicle roof having a pinch detection system using sonic waves according to the present embodiments.

FIG. 5 shows an adjusted peak detector voltage over temperature using test data.

FIG. 6 shows signal attenuation of a straight sonic tube over length.

### DETAILED DESCRIPTION OF THE EMBODIMENTS

The present embodiments provide movable panel applications for an opening of a vehicle (such as a sunroof). Particularly, the present embodiments provide pinch detection from movable panels, such as for an opening of a vehicle roof, and particularly to a pinch detection system and method for a movable panel using integrated sonic waves transmitted within a deformable and resilient channel.

The above described deficiencies in the art of pinch detectors for movable panels can include high cost, fragility over product life, radiated emissions, space requirements and installation difficulties. Such detectors have used various technologies including resistive/contact strips, capacitance, inductance, optic wave, air pressure, and the like. The present embodiments address these deficiencies by providing a pinch detection system using sonic waves. The sonic waves can optionally be pulsed (modulated), and in an inaudible range for at least humans, but preferably also above the range of most animals that may occupy a vehicle. The system can provide a sound generator (transmitter) at one end of a deformable and resilient sonic tube and a receiver at the other. As sound is transmitted, a controller ‘listens’ for the sound and can trigger a command if the sound attenuates below a predetermined threshold or even when the signal is lost. The embodiments can provide a primary or even secondary (redundant) system for pinch detection.

The operating principle of the present embodiments is that as a tube is pinched either by closure of the roof panel against a sealing element or by an obstruction between the moving panel and the sealing element, less and/or altered sound travels through the occluded sonic tube. Once the threshold is reached, the system can trigger a command to signal the vehicle operator (such as a light or audible signal), cease movement of a panel, or reverse panel movement. It is noted that while the present embodiments are described for a movable panel on a vehicle roof, such as a sunroof or moon roof, that any movable panel could benefit including but not limited to a building's windows, doors, garage doors, and the like. In short, any panel structure that can be associated against a deformable tube can apply the present embodiments. The present embodiments can assist in the deployment of products using large movable panels, unattended panel closures, high speed panel closures, and the like.

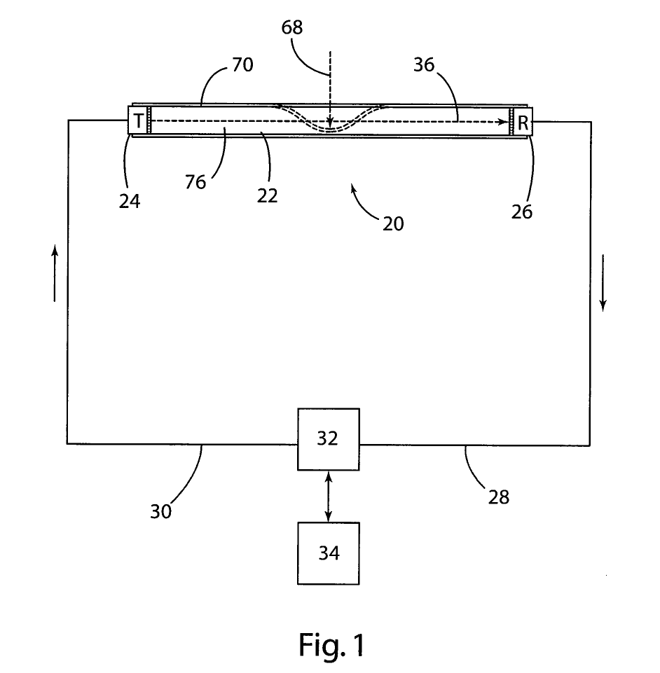

Turning now to the figures, FIG. 1 shows a general schematic of a pinch detection system using sonic waves according to the present embodiments and is generally indicated at 20. The primary components of pinch detection system 20 can include a sonic wave 36 generating device (transmitter) 24, a sonic tube 22, a sonic wave receiver 26, all controlled by controller 32. Controller 32 can be connected to transmitter 24 by connector 30, and to receiver 26 by connector 28. Controller 32 can also receive additional input from optional sensors 34. Controller 32 can also have predetermined calibrations of the input from receiver 26 in determining whether to trigger a command. These calibrations are discussed below.

Sonic tube 22 can be made from a variety of materials, but needs to be able to form a hollow channel 76 that is deformable and resilient. Deformable, in that it can yield to an external pressure (such as shown at 68 in FIG. 1), yet resilient in that it will return to its original shape after the external pressure is removed without permanent damage or rupture. Various materials such as rubber (including ethylene propylene diene monomer-EDPM rubber), latex, foams, combinations thereof, and the like can be used to form sonic tube 70. Other variables in determining a specification for a sonic tube (discussed below) can include the length of tubing needed, changes over temperature variation, interior channel surface, channel wall 70 thickness, and channel interior 76 profile (e.g., round, square, etc). Tube length can vary and can be used up to about 4500 mm for some embodiments. It is noted though that various combinations of channel compositions, amplitude, frequency, and the like could allow additional length variations.

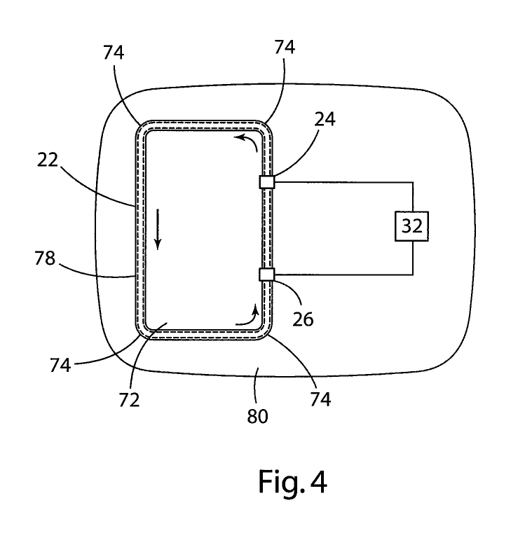

As shown in FIG. 4, in vehicle applications, sonic tube 22 can be the sealing element 78 of a movable panel 72 of a vehicle roof 80. As shown in FIG. 4, sonic tube 22 would have 4 bends 74 and its length would be the perimeter of vehicle roof opening (preferably about 3 to 4 meters). It is noted though that sonic tube 22 could also be configured as a separate element apart from the sealing member at any point where pinch detection is desired in the path of the movable panel 72.

Preferable, sonic wave pinch detector 20 works even when sonic tube 22 has a predetermined maximum level of holes or tears that breach the channel interior 76. As shown below, the system can be configured and tested to account for varying amounts of channel interior 76 breach. Further, the resilient nature of sonic tube 22 allows tears to close and minimally affect performance of this system. This result is not known for other pinch detection device using, for example, contact strips. If a contact or pressure switch is breached, the system would fail.

Transmitter 24 can be selected based on a desired application on the basis of its frequency and amplitude, which may or may not be controllable by controller 32. Frequency ranges can be anywhere from about 4 kHz to about 60 kHz. Preferably, the transmitter uses a range of about 30 to 50 kHz, and most preferably about 40 kHz. For example, in other vehicle applications, such as a back-up or lane change sensor, a 40 kHz transmitter is preferred. This frequency is not audible to humans and most animals that may be in or around a vehicle. Also, transmitter 24 can modulate its sonic wave pattern to provide a distinct wave pattern distinguishable from background noise in the environment of the system.

Transmitter 24 amplitude can also vary by application, though a range of about 3 to 24 volts is preferred for vehicle applications, and most preferred about 5 to 10 volts. A preferred transmitter 24 can be driven by a signal ranging from −2.5 to +2.5 V. This can be done so only a 5 V regulator is needed. However, in other embodiments, it may be better for transmitter 24 to be driven by a signal ranging from −5 to +5 V. This may require either an additional 10 V regulator or a voltage doubling circuit. Receiver 26 is preferably matched to receive the range of frequency and amplitude of transmitter 24. For illustrative purposes only, an exemplary transducer pair of transmitter and receiver can be a 40 kHz transmitter and receiver sold under the part numbers 400ST10P and 400SR10P respectively. These were tested successfully under typical automotive operating temperature ranges between about −40 to 85 degrees Celsius.

It is noted that the transmitter and receiver should also be paired, and the system calibrated for that pair to the sonic tube 22 specifications such as sonic wall thickness 70, channel interior 76 dimension, channel length, bend number, and the like.

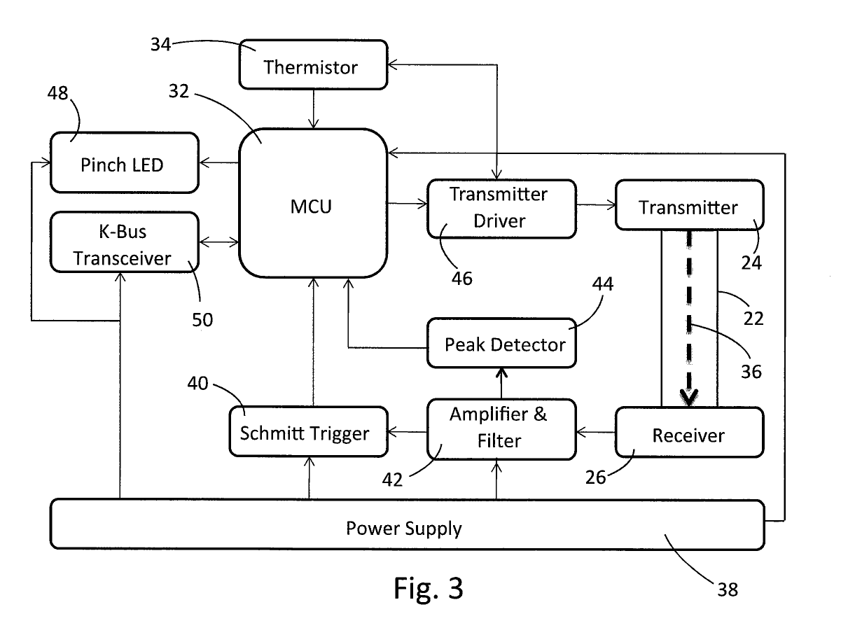

FIG. 3 shows a more detailed hardware block diagram of a pinch detection system using sonic waves according to the present embodiments. It is noted that the present embodiments may be practiced in a variety of ways and the embodiment present in FIG. 3 is for illustrative purpose. Additional components to those described above include a thermistor 34, a power supply 38, a Schmitt Trigger 40, amplifier and filter 42, peak detector 44, transmitter driver 46, output trigger, such as an LED 48 and a K-bus transceiver 50. Controller 32 controls the hardware and can be integrated into a sunroof controller or part of the vehicle control area network. K-Bus transceiver 50 can utilize communication ports on controller 32 into one K-Bus line and can be used to monitor the system.

Sensor 34 can be a separate temperature gauge or a thermistor as shown in FIG. 3. A thermistor's resistance varies as a function of temperature. Thus, a thermistor can be used to measure the temperature of the environment in which it resides. A thermistor can be used by the controller to apply an adjustment to the peak detector input signal before further use by the system. Alternately, system 20 can be configured so that as temperature varies, and the resistance of the thermistor changes, the voltage of the transmitter 24 also varies as applied by transmitter driver 46. Thermistor 34 can be, for example, one sold under a part number NCP18XH103F0SRB.

Amplifier and filter circuit 42 takes an input sinusoidal signal from receiver 26, amplifies and filters it, and then gives it a 2.5 VDC offset for use in both Schmitt trigger 40 and peak detector 44.

Schmitt trigger 40 can be used to convert the sinusoidal signal from the amplifier and filter hardware into the discrete form required for input in a digital port of controller 32. For example, it can convert an input sine wave offset by 2.5 VDC to an output square wave that varies from zero to five volts DC. When the output becomes high or low is determined by predetermined upper and lower trigger thresholds.

Peak detector 44 can be used to determine an approximate amplitude of the received sinusoidal signal after amplification by the amplifier and filter 42. For example, if a partial pinch of sonic tube 22 occurs, the amplitude of the sinusoidal signal transmitted through (sonic wave 36) the sonic tube is attenuated. As such, the peak detector can be configured to determine if a partial pinch event occurs. For example, for a 5 volt system, peak detector 44 can send a signal to controller 32 that a threshold (e.g., about 3.2 volts) of attenuation has occurred, thus triggering the controller to send a command, such as to illuminate pinch LED 48. It is noted though that signal calibration would have already been applied for environmental variations and the like. It is also noted though that the threshold amplitude is configured for the specific applications and desired thresholds associated with the desired sensitivity of the system. Further, although a command to illuminate an LED is illustrated, other commands such as stopping or reversing the direction of a moving panel are also possible.

Once the system hardware is established, it should be calibrated and/or configured to issue predetermined commands with a high level of predictability. Calibration of sensor 34 is important especially due to system variation from temperature fluctuations. Other system calibration factors can include the number of channel bends, interior surface finish of the channel, channel composition, channel breaches, channel length, sonic tube wall thickness, sonic wave frequency and amplitude, anticipated background noise, combinations thereof, and the like.

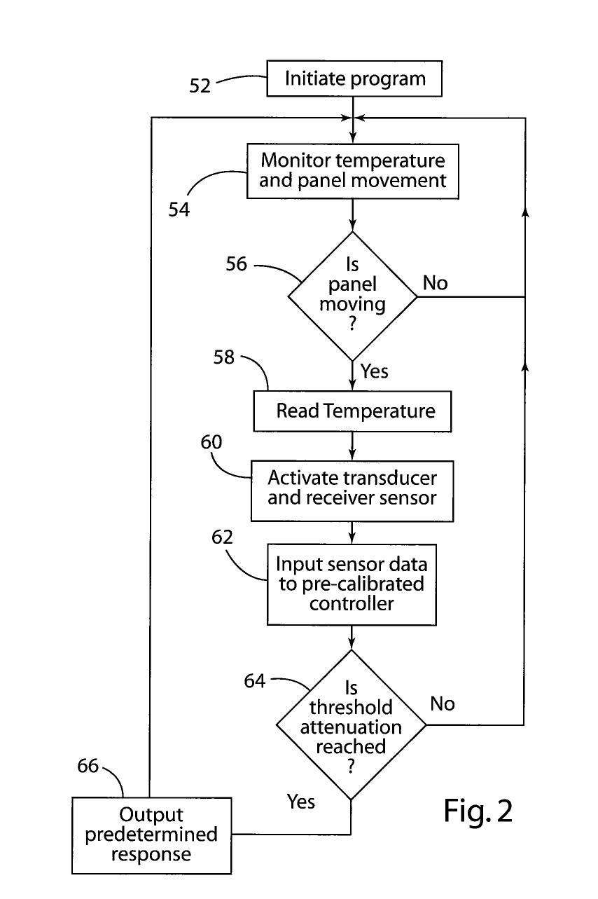

Controller 32 can provide the system input and outputs. An example of one such system is shown in FIG. 2 for a better understanding of how such a system can operate. As shown, the system can initiate at step 52. Initiation can be the result of a vehicle going to an engine-on or accessory mode. The system then begins monitoring at step 54. Monitoring examples can include monitoring the movement of the panel and the temperature of the environment. If panel movement is detected at step 56, the system can read sensor temperature at step 58, activate transmitter 24 and receiver 26 at step 60, and calibrate and input sonic wave amplitude to controller 32 at step 62. If the predetermined threshold is reached at step 64, the predetermined command can occur at step 66.

The calibration steps described above in some instances can benefit from testing various sonic tube 22 configurations in various conditions that can be anticipated during operation. For the present embodiments, test data was collected for calibration from 4 exemplary sonic tube 22 variations as set forth in the following table:

TABLE
Sample Sonic Tubes Tested

| Designator | Properties | |
|---|---|---|
| Tube 1 | Material: | Latex |
| | Cross Section: | Circular |
| | | 5.08 mm (0.2 in)—inner diameter |
| | | 1.75 mm (0.069 in)—thickness |
| Tube 2 | Material: | Latex |
| | Cross Section: | Circular |
| | | 5.08 mm (0.2 in)—inner diameter |
| | | 1.14 mm (0.045 in)—thickness |
| Tube 3 | Material: | EPDM rubber |
| | Cross Section: | Non-standard |
| | Description: | Sealing element from sunroof |
| Tube 4 | Material: | Latex |
| | Cross Section: | Circular |
| | | 9.53 mm (0.375 in)—inner diameter |
| | | 1.59 mm (0.0625 in)—thickness |

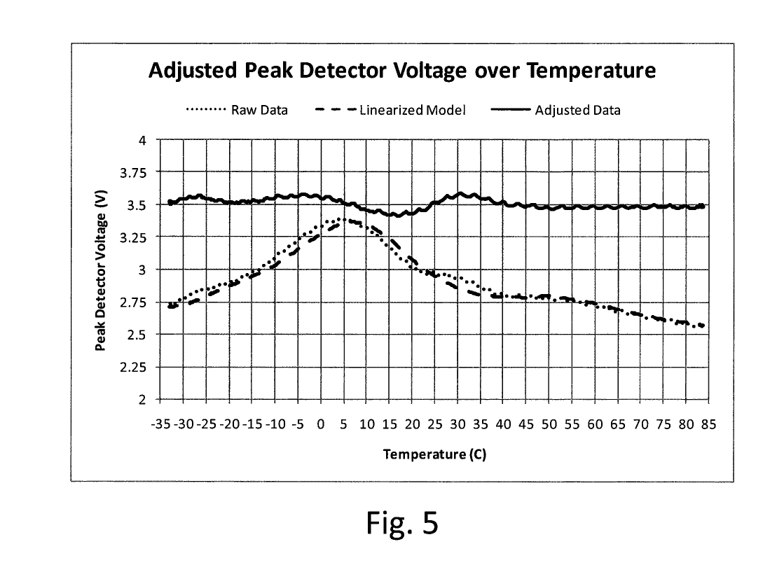

Temperature variation can be tested and programmed into system software and peak detector 44 voltages can be adjusted. The effect of adjusting the peak detector voltage can be shown in FIG. 5. In FIG. 5, the top line represents an adjusted peak detector voltage over temperature using test data. The lower line (showing its smoothed linear regression line) is exemplary test data. Using FIG. 5, a further calibration step of determining the low amplitude threshold can be performed. The chosen threshold should be below the lowest voltage seen on the adjusted data so that the system can function properly over the temperatures tested. For this specific test data Tube 1 (as described above) at a length of about 1800 mm, the lowest peak detector voltage was about 3.4 V. After factoring in a margin and calibration, the final threshold can be set to 3.2 V. This value can then be entered into the software.

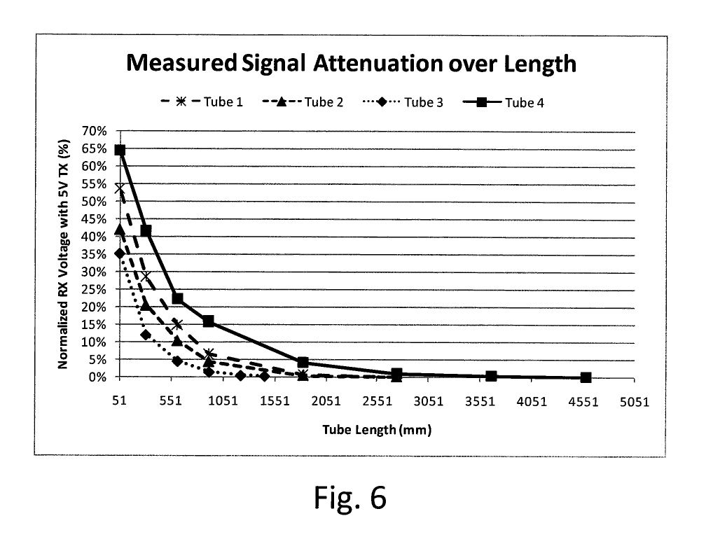

Other test factors for system calibration can include sonic wave attenuation as a function of sonic tube 22 length. An exemplary test could include a straight tube test at ambient temperature (e.g., about 25 degrees Celsius) since temperature has already been adjusted as described above. The results of testing various tube lengths (about at 50 mm to 4500 mm) at 5 Volt amplitude and 40 kHz is shown in FIG. 6. As shown, as the length of tube increases, the percentage of signal received declines at an exponential, but predicable rate. Thus, an exponential equation can be used to calibrate the system.

Testing can also be useful to predict the effect of the number and types of bends in sonic tube 22. This is useful in applications where sonic tube 22 is the sealing element of a movable panel. As shown in FIG. 4, at least 4 channel bends 74 could be predicted. The bends, as tested had a radius of about 33 mm, which is smaller than most sunroof corner radii for sealing elements. The test found no significant changes in attenuation for up to 4 sonic tube bends.

Other test factors can include susceptibility to background noise and a determination of how much of the signal is transmitted outside of the tube. This can be a factor to determine the effect transmitter 24 has on other vehicle systems. In addition, animals with a hearing range as high as 40 kHz could experience discomfort from the sensor if it is not attenuated enough outside of the tube.

While the embodiments and methods have been described in conjunction with specific embodiments, it is evident that many alternatives, modifications, and variations will be apparent to those skilled in the art in light of the foregoing description.

We claim:

1. A pinch detection system, comprising:
a deformable and resilient channel;
a sonic wave transmitter at one end of the channel having a predetermined output;
a sonic wave receiver at a second end of the channel; and
a controller connected to the transmitter and receiver;
wherein the controller selectively activates the transmitter and the controller generates a command in response to a predetermined attenuation of sonic wave input from the sonic wave receiver.

2. The pinch detection system of claim 1, wherein the predetermined output of the sonic wave transmitter is in the range of about 30 to 50 kHz at a range of about 3 to 24 volts.

3. The pinch detection system of claim 1, wherein the predetermined output of the sonic wave transmitter is about 40 kHz at about 5 volts.

4. The pinch detection system of claim 1, wherein the deformable and resilient channel is disposed within a sealing element of a movable panel.

5. The pinch detection system of claim 1, wherein the deformable and resilient channel is composed of a material selected from the list consisting of latex, rubber, EPDM, foam, and combinations thereof.

6. The pinch detection system of claim 1, wherein the sonic wave is modulated.

7. The pinch detection system of claim 1, wherein the controller predetermines input of the sonic wave receiver at the second end of the channel based on factors consisting of: present channel temperature, thermistor temperature, number of channel bends, interior surface finish of the channel, channel composition, channel breaches, channel length, sonic tube wall thickness, sonic wave frequency and amplitude, anticipated background noise, and combinations thereof.

8. The pinch detection system of claim 4, wherein the controller command in response to a predetermined attenuation of sonic wave input from the sonic wave receiver includes commands selected from the list consisting of activating an LED, activating an audible sound, commanding a movable panel to stop movement, reversing movable panel direction, and combinations thereof.

9. A method to detect pinching of a deformable and resilient channel, comprising:
generating a sonic wave at one end of the channel at a predetermined output;
sensing the sonic wave at a second end of the channel at a predetermined input; and
outputting a signal in response to a predetermined attenuation of the sensed sonic wave.

10. The method of claim 9, wherein the step of generating the sonic wave includes modulating the sonic wave.

11. The method of claim 9, wherein the outputting of a signal comprises generating a command to light an LED.

12. The method of claim 9, wherein the outputting of a signal comprises generating a command to stop movement of a movable panel.

13. The method of claim 9, wherein the outputting of a signal comprises generating a command to reverse movement of a movable panel.

14. The method of claim 9, further comprising calibrating the predetermined attenuation of the sensed sonic wave based on a factors consisting of the present channel temperature, thermistor temperature, number of channel bends, interior surface finish of the channel, channel composition, channel breaches, channel length, sonic tube wall thickness, sonic wave frequency and amplitude, anticipated background noise, and combinations thereof.
